(19) United States
(12) Patent Application Publication
(10) Pub. No.: US 2016/0066374 A1
(43) Pub. Date: Mar. 3, 2016

(54) HIGH-POWER RETROFIT LED LAMP WITH ACTIVE AND INTELLIGENT COOLING SYSTEM FOR REPLACEMENT OF METAL HALID LAMP AND HIGH-PRESSURE SODIAM LAMP

(71) Applicants: Peter Shen, Beijing (CN); Chris Miao, Beijing (CN)

(72) Inventors: Peter Shen, Beijing (CN); Chris Miao, Beijing (CN)

(21) Appl. No.: 14/698,506

(22) Filed: Apr. 28, 2015

Related U.S. Application Data
(63) Continuation of application No. PCT/CN2015/077041, filed on Apr. 21, 2015.

(30) Foreign Application Priority Data
Aug. 28, 2014 (CN) 201410429783.5

(51) Int. Cl. H05B 33/08; F21V 29/70; F21V 23/00; F21V 29/83; F21V 29/58; F21V 23/02; F21K 99/00; F21V 29/67

(52) U.S. Cl. CPC H05B 33/0815; H05B 33/0845; F21K 9/1355; F21V 29/70; F21V 29/67; F21V 29/83; F21V 29/58; F21V 23/023; F21V 23/009; F21Y 2101/02

(57) ABSTRACT

The present invention relates to the field of electric illuminator technology, in particular, to a high-power retrofit Light Emitting Diode (LED) lamp and a radiator assembly therein as replacement for metal halide lamp and high-pressure sodium lamp. The high-power retrofit LED lamp for replacement of metal halide lamp and high-pressure sodium lamp is provided, comprising a main substrate, an active cooling assembly comprising a radiator and a radiator base plate, a backlight substrate, and a screw base, wherein the main substrate is mounted on the lower side of the radiator base plate, the backlight substrate is mounted on an upper side of the radiator base plate, the backlight substrate is substantially in the shape of a ring and situated around the radiator, wherein the main substrate is configured to generate light illuminating downwards, the backlight substrate is configured to generate light illuminating upwards, and the screw base is configured to fit into a socket of a metal halide lamp or a high-pressure sodium lamp.

### CROSS-REFERENCES TO RELATED APPLICATIONS

This application is a continuation of International Patent Application No. PCT/CN2015/077041 filed Apr. 21, 2015, which claims priority to Chinese patent application No. 201410429783.5 filed on Aug. 28, 2014 and entitled “Microgroove Composite Phase-Change Cooling Based LED Lamp As An Alternative To A Metal Halide Lamp”, which are incorporated herein by reference in its entirety.

### TECHNICAL FIELD

The present invention relates to the field of electric illuminator technology, in particular, to a high-power retrofit Light Emitting Diode (LED) lamp with an active and intelligent cooling system for replacement of metal halide lamp and high-pressure sodium lamp.

### BACKGROUND

A lot of residential, commercial and industrial settings need to be well lighted by high-power lamps, such as metal halide lamp (MHL) and high-pressure sodium lamp (HPS).

The metal-halide lamps generate light by passing an electric arc through a gaseous mixture of vaporized mercury and metal halides. The metal halide lamps have a high luminous efficiency and produce an intense white light. The metal halide lamps are used in wide area overhead lighting of commercial, industrial, and public spaces, such as parking lots, sports arenas, factories, and retail stores, as well as residential security lighting and automotive headlamps.

The high-pressure sodium lamps generate light by passing an electric arc through a gaseous mixture of vaporized mercury and sodium under high pressure. The high-pressure sodium lamps produce a dark pink glow when first struck, and an intense pinkish orange light when warmed. This leads them to be used in areas where improved color rendering is important or desired, and they have been widely used for outdoor area lighting such as streetlights and security.

Both the metal halide lamp and high-pressure sodium lamp are driven by a ballast, which generates a high voltage applying across the two ends of the lamp to ignite it and stabilizes the current flowing through the lamp. The metal halide lamp and high-pressure sodium lamp have a moderate lifespan between 10,000 to 20,000 hours and relatively poor lumen maintenance, generally having very rapid lumen depreciation in 3,000 to 5,000 hours.

Both the metal halide lamp and high-pressure sodium lamp are not very convenient to use. For example, it takes about 5 minutes for the metal halide lamp to come to full brightness, and after turning off, the metal halide lamp must be allowed to cool for up to 20 minutes before it can be restarted. Furthermore, both the metal halide lamp and high-pressure sodium lamp are hazardous and risky to use. They contain a significant amount of mercury and are prone to risk of explosion due to the high pressure inside the lamps. Because of the mercury content, they must also be properly disposed.

LED lighting is a significant improvement over conventional lighting because LEDs have higher efficiency, a long lifespan of 50,000 hours and are RoHS compliant, i.e. they do not contain mercury or other toxic substances. A conventional LED lamp basically includes an electroluminescent semiconductor chip affixed to a support with silver adhesive and connected with a circuit board via silver wires or gold wires. The semiconductor chip is sealed with epoxy resin to protect both the chip and the wires, and the sealed chip is installed in a housing. Therefore, the LED lamp has good mechanical performance.

It is well known that the service life of an illumination product, especially an LED lamp with high power, depends on the heat dissipation performance of the illumination product. Conventional LED lamps generally do not have good heat dissipating performance, and consequently, the power of the conventional LED lamps rarely exceeds 100 W, as conventional LED lamps tend to overheat when its power exceeds 150 watt. Consequently, conventional LED lamps generally do not generate sufficient light to be used as a replacement of high power (>150 watt) metal halide lamp and high-pressure sodium lamp unless it is attached to a large and unwieldy metal heat sink. Furthermore, the light generated by conventional LED lamps is highly directional, and tends to produce a dark celling when used indoor. Therefore, there is a need to develop high-power LED lamps with good heat dissipating performance and optimal light distribution pattern for the replacement of the metal halide lamp and high-pressure sodium lamp.

### SUMMARY

An objective of the present invention is to provide a high-power retrofit LED lamp with an active and intelligent cooling system for replacement of metal halide lamp and high-pressure sodium lamp driven by a magnetic ballast. In accordance with the embodiments of the present invention, the heat dissipation performance of the LED lamp is effectively improved, the size of the radiator and the weight of the LED lamp are reduced, the light distribution pattern of the LED lamp is optimized, and the LED lamp can directly replace the existing metal halide lamp and high-pressure sodium lamp.

To achieve the above objective, the following technical solutions of the present invention are provided.

A high-power retrofit LED lamp for replacement of metal halide lamp and high-pressure sodium lamp is provided, comprising a main substrate, an active cooling assembly comprising a radiator and a radiator base plate, a backlight substrate, and a screw base, wherein the main substrate is mounted on the lower side of the radiator base plate, the backlight substrate is mounted on an upper side of the radiator base plate, the backlight substrate is substantially in the shape of a ring and situated around the radiator, wherein the main substrate is configured to generate light illuminating downwards, the backlight substrate is configured to generate light illuminating upwards, and the screw base is configured to fit into a socket of a metal halide lamp or a high-pressure sodium lamp.

Preferably, the active cooling assembly further comprises a cooling fan, wherein the cooling fan is situated above the radiator.

Preferably, the LED lamp further comprises a housing substantially in the shape of truncated cone, wherein the housing is made of a non-heat conducting plastic material, and comprises a plurality of holes configured to allow the outflow of hot air out of the LED lamp.

Preferably, the LED lamp further comprises a connection sleeve and a power supply board, wherein a top end of the connection sleeve is connected to a bottom end of the screw base, and the power supply board is situated inside the connection sleeve.

Preferably, a first power supply line on the power supply board is welded to the main substrate through the radiator and the radiator base plate, and a second power supply line on the power supply board is welded to the screw base through the connection sleeve.

Preferably, the power supply board comprises a first bridge rectifier configured to convert AC electric current supplied by a magnetic ballast for the metal halide lamp or high-pressure sodium lamp to DC power output for the main substrate and the backlight substrate.

Preferably, the power supply board comprises a second bridge rectifier configured to convert AC electric current supplied by the magnetic ballast to DC power output for the cooling fan.

Preferably, the power supply board further comprises a MCU control circuit, wherein the second bridge rectifier is configured to supply DC power output for the MCU control circuit.

Preferably, the power supply board further comprises an overheat protection circuit, wherein the MCU control circuit is configured to control the cooling fan in accordance with a signal from the overheat protection circuit.

Preferably, the power supply board further comprises a dimming circuit.

Preferably, the power supply board further comprises a power on detection circuit, wherein the MCU control circuit is configured to control the intensity of the light generated by the LED lamp through the light modulator in accordance with a signal from the power on detection circuit.

Preferably, the screw base is compatible with E39, EX39, and E40 mogul bases.

Preferably, the intensity of the light generated by the backlight substrate is between 5% and 15% of the intensity of the light generated by the main substrate.

Preferably, the radiator comprises a hollow heat dissipation tube configured to dissipate heat by phase-change heat absorption, a top and a bottom of the hollow heat dissipation tube are respectively configured as a condensation end and an evaporation end, the interior of the hollow heat dissipation tube is filled with a working medium and maintained at a negative pressure.

Preferably, a wall of the hollow heat dissipation tube comprises a heat absorption core configured to convey the working medium in a liquid state back to the evaporation end, and the heat absorption core is made of capillary porous material.

Preferably, the radiator comprises a plurality of heat dissipation fins of a wave or sawtooth shape radially distributed on the exterior radiator.

Preferably, the backlight substrate comprises a plurality of backlight aluminum substrates connected in series via bonding wires.

Preferably, the LED lamp has a weight of no greater than 1.1 kilogram, and is configured to generate no less than 20,000 lumens.

Preferably, the radiator has a height of about 35 millimeters.

### DESCRIPTION OF DRAWINGS

FIG. 1 is a schematic diagram showing the structure of a retrofit LED lamp as replacement for metal halide lamp, according to an embodiment of the present invention.

FIG. 2 is a schematic diagram showing the structure of a heat radiator according to the embodiment of the present invention.

FIG. 3 is a schematic diagram showing the structure of a retrofit LED lamp as replacement for metal halide lamp and high-pressure sodium lamp, according to an embodiment of the present invention.

FIG. 4 is a schematic diagram showing the appearance of a retrofit LED lamp as replacement for metal halide lamp and high-pressure sodium lamp, according to the embodiment of the present invention.

FIG. 5 is a schematic diagram of a circuit board for high-power retrofit LED lamp as replacement for metal halide lamp and high-pressure sodium lamp, according to an embodiment of the present invention.

### DETAILED DESCRIPTION OF THE EMBODIMENTS

Technical solutions of the present invention will be further described below in conjunction with the accompanying drawings and specific embodiments.

### Embodiment One

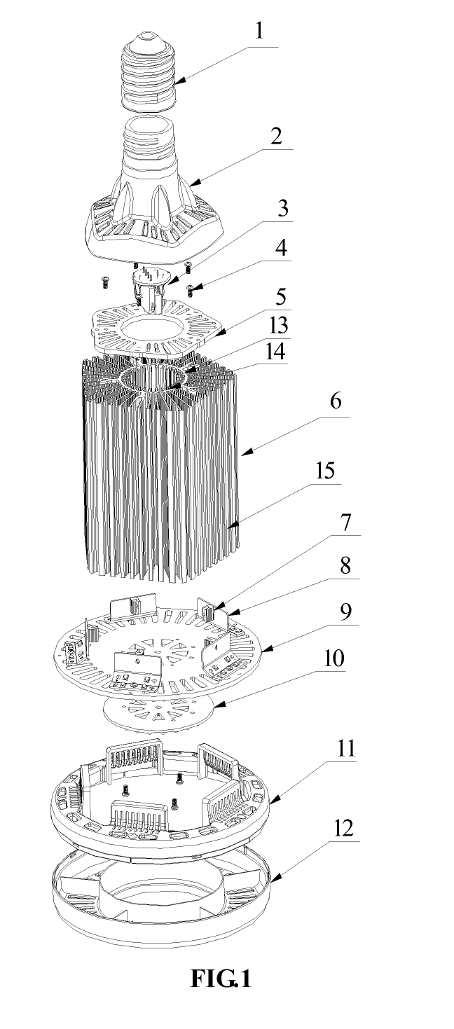

FIG. 1 is a schematic diagram showing the structure of a retrofit LED lamp as replacement for metal halide lamp, according to an embodiment of the present invention.

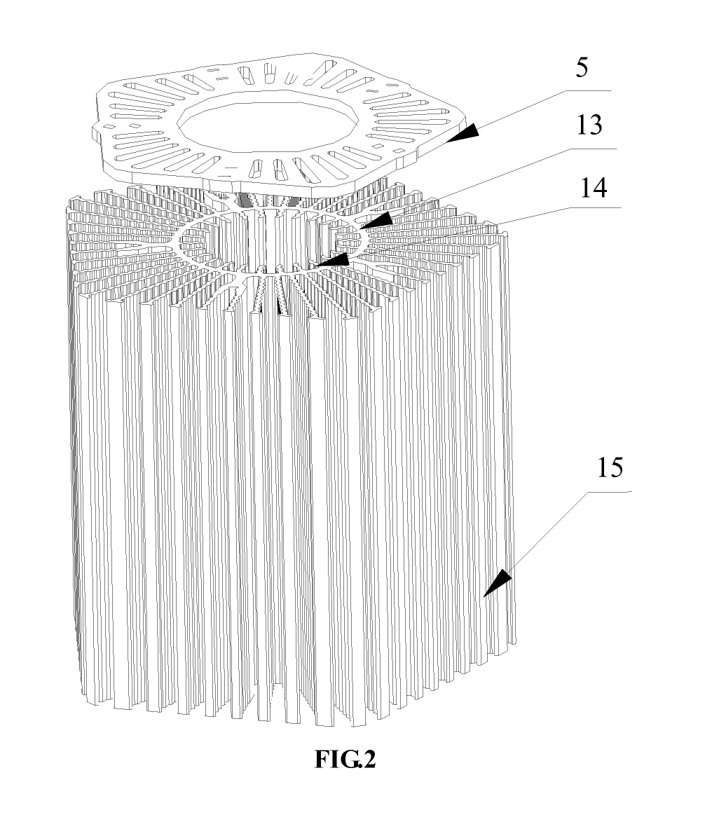

FIG. 2 is a schematic diagram showing the structure of a heat radiator according to the embodiment of the present invention.

Reference numeral list

| | |
|---|---|
| 1: Screw base | 2: Connection sleeve |
| 3: Power supply board | 4: Screw |
| 5: Radiator cover plate | 6: Radiator |
| 7: Latch block | 8: Backlight aluminum substrate |
| 9: Radiator base plate | 10: Main aluminum substrate |
| 11: Rear housing | 12: Front housing |
| 13: Hollow heat dissipation tube | 14: Heat absorption core |
| 15: Radiator fin. | |

As shown in FIGS. 1 and 2, a retrofit LED lamp as replacement for metal halide lamp and high-pressure sodium lamp, includes a radiator assembly, a connection sleeve assembly, and a lamp housing assembly. The radiator assembly includes a radiator 6, a radiator cover plate 5 and a radiator base plate 9. The radiator cover plate 5 and the radiator base plate 9 are respectively installed fixedly at the top and bottom of the radiator 6 by screws 4.

The radiator 6 includes a hollow heat dissipation tube 13 with a phase-change heat absorption capability. The interior of the hollow heat dissipation tube 13 is filled with a working medium and is maintained at a negative pressure. The ends of the hollow heat dissipation tube 13 function as a condensation end and an evaporation end, respectively. An LED bulb is arranged near the evaporation end.

The working medium has a low boiling point and is volatile. The wall of the hollow heat dissipation tube 13 comprises a heat absorption core 14 configured to convey the working medium in liquid state back to the evaporation end. The heat absorption core 14 is made of capillary porous material, which is able to convey the cooled and condensed liquid working medium back to the evaporation end.

When the evaporation end of the hollow heat dissipation tube 13 is heated, the working medium is changed from liquid state to gas state by absorbing the heat. The working medium in the gas state flows toward the condensation end under the action of a small pressure difference, dissipates the heat at the condensation end, and is re-condensed to the liquid working medium which then flows back to the evaporation end along the heat absorption core 14 under the action of a capillary force. As such, with the repeated phase changes of the working medium, the heat is transferred from the evaporation end to the condensation end.

Preferably, the hollow heat dissipation tube 13 is further externally connected with a plurality of radiation fins 15 each having a wave or sawtooth shape. The plurality of radiation fins 15 are radially distributed on the exterior of the hollow heat dissipation tube 13. The wave or sawtooth shape of the heat dissipation fins is useful to increase a heat dissipation area of the hollow heat dissipation tube 13.

Specifically, a plurality of backlight aluminum substrates 8, which evenly distribute light on the upside and the outside of the retrofit LED lamp to be used as replacement for metal halide lamp and high-pressure sodium lamp, are evenly distributed on the outside of the heat dissipation fins 15. The plurality of backlight aluminum substrates 8 are mounted vertically on the radiator base plate 9 and affixed via screws, and have a shape mated with that of the radiator 6.

The lower side of the radiator base plate 9 is connected with a main aluminum substrate 10, which is affixed to the lower side of the radiator base plate 9 by screws. A power supply board 3 is installed on the radiator cover plate 5. A connection sleeve 2 is affixed onto the radiator cover plate 5 by screws, and accommodates the power supply board 3. The connection sleeve 2 accommodating the power supply board 3 therein is filled with sealing gum.

Preferably, a latch block 7 is arranged on the inward side of the backlight aluminum substrate 8. The radiation fin corresponding to the latch block 7 comprises a slot, so that the latch 7 can be latched into the slot of the corresponding radiation fin. Preferably, a latch opening running through the latch block 7 is arranged longitudinally in the latch block 7. A matching pair of wave or sawtooch shaped structures are located outside of the latch block 7 and inside of the slot, respective. Alternatively, the matching pair of wave or sawtooch shaped structures can be located outside of the latch block 7 and inside the slot, respectively.

Specifically, the plurality of backlight aluminum substrates 8 are connected in series via bonding wires, which pass through the radiator base plate 9 and are welded to the front surface of the main aluminum substrate 10. The connection sleeve assembly includes the connection sleeve 2, a screw base 1 and the power supply board 3.

Specifically, one power supply line from the power supply board 3 is welded to the main aluminum substrate 10 after passing through the radiator cover plate 5, the radiator 6 and the center of the radiator base plate 9 in sequence, and another power supply line from the power supply board 3 is welded to the screw base 1 after passing through the connection sleeve 2. The top of the connection sleeve 2 is screwed to the bottom of the screw base 1, and the power supply board 3 is arranged inside the connection sleeve 2.

The lamp housing assembly includes a rear housing 11 and a front housing 12. The rear housing 11 is affixed at the periphery of the radiator base plate 9 by screws, the lower side of the rear housing 11 is affixed to the front housing 12, and an installation opening for installing an LED bulb is arranged inside the front housing 12.

Preferably, the power supply board 3 is further connected with a dimming circuit, and a regulator of the dimming circuit is installed on a control board. The control board is configured to control the dimming circuit, so that the intensity of the retrofit LED lamp as replacement for metal halide lamp and high-pressure sodium lamp, can be adjusted as desired by a user.

A cooling fan is arranged at one side of the main aluminum substrate 10 and connected with the control board. The cooling fan functions either as a primary or an auxiliary cooling device. For example, when detecting that a temperature of the main aluminum substrate 10 sensed by a temperature sensor installed near the main aluminum substrate 10 is higher than the temperature preset by the user, the control board starts the cooling fan.

Further, the control board may further comprise a signal receiver. A remote control device mated with the signal receiver may send an instruction to the signal receiver to control the composite phase-change cooling based LED lamp as replacement for metal halide lamp and high-pressure sodium lamp. The remote control device makes it more convenient to use and operate the composite phase-change cooling based LED lamp.

As can be seen from the above description, the above-described radiator assembly makes full use of the principle of phase-change heat absorption to effectively improve the heat dissipation performance of the radiator of the composite phase-change cooling based LED lamp An cooling fan is also added to further reduce the size of the radiator and the weight of the composite phase-change cooling based LED lamp so that the composite phase-change cooling based LED lamp has better safety, stability and reliability performances to effectively replace high power (>150 watt) metal halide lamp and high-pressure sodium lamp.

### Embodiment Two

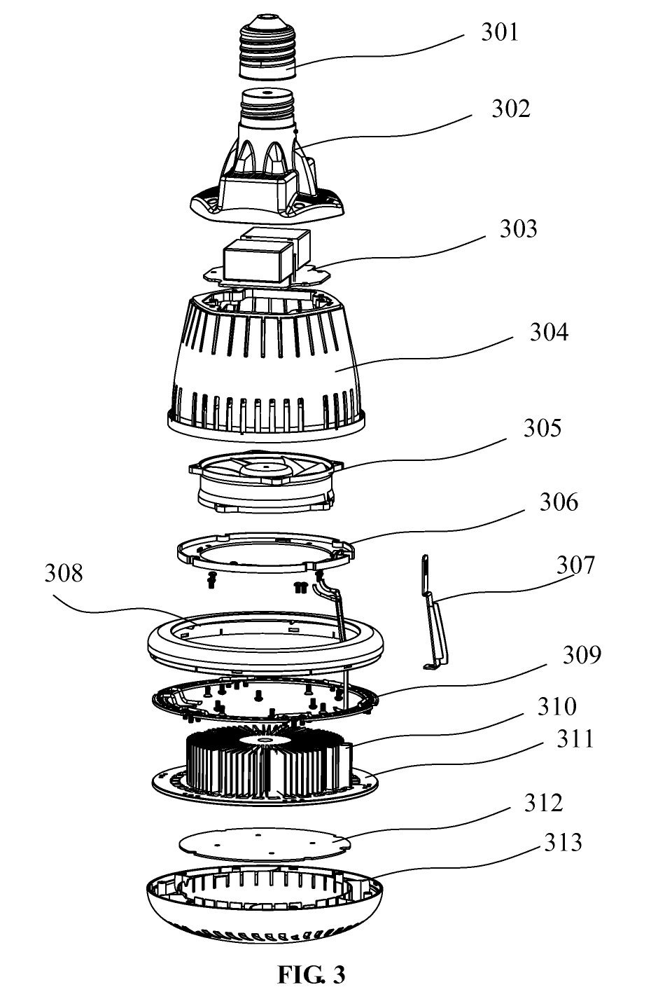

FIG. 3 is a schematic diagram showing the structure of a retrofit LED lamp as replacement for metal halide lamp and high-pressure sodium lamp, according to an embodiment of the present invention.

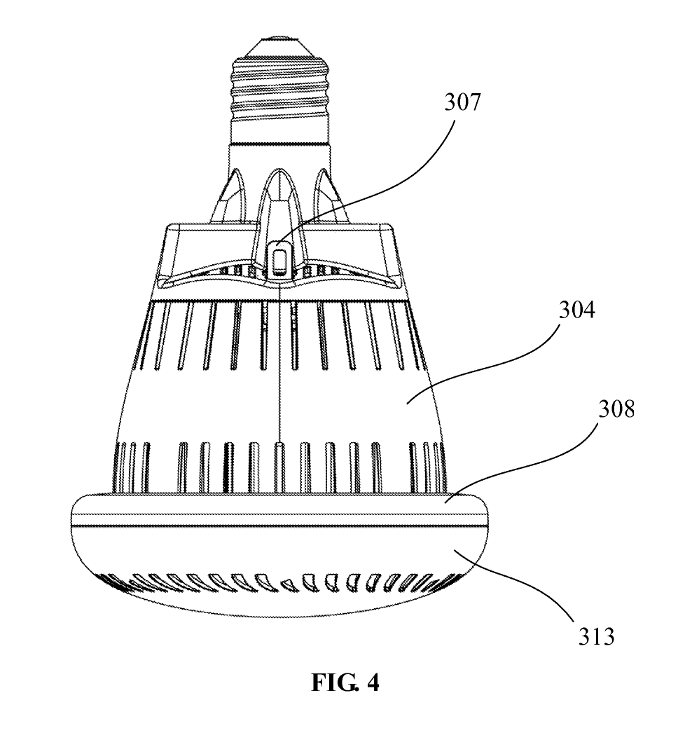

FIG. 4 is a schematic diagram showing the appearance of a retrofit LED lamp as replacement for metal halide lamp and high-pressure sodium lamp, according to the embodiment of the present invention.

Reference numeral list

| | |
|---|---|
| 301: Screw base | 302: Connection sleeve |
| 303: Power supply board | 304: Housing |
| 305: Fan | 306: Divider ring |
| 307: Hook | 308: Back cover |
| 309: Backlight substrate | 310: Radiator |
| 311: Radiator base plate | 312: Main substrate |
| 313: Main Cover | |

As shown in FIGS. 3 and 4, a retrofit LED lamp as replacement for metal halide lamp and high-pressure sodium lamp, includes a screw base 301, a connection sleeve 302, a power supply board 303, a housing 304, a fan 305, an divider ring 306, a hook 307, a back cover 308, a backlight substrate 309, a radiator 310, a radiator base plate 311, and a main substrate 312, and a main cover 313.

As shown in FIG. 3, the radiator 310 in this embodiment has a plurality of radiation fins radially distributed on the exterior, and forms a cylinder-shaped structure. The radiator 310 can either be a conventional radiator or have a similar structure as the radiator 6 in the previous embodiment. The backlight substrate 309 is ring-shaped, and situated around the radiator 310. The backlight substrate 309 is mounted on the upper side of the radiator base plate 9, and the main substrate 312 is mounted on the lower side of the radiator base plate 9.

In this embodiment, the light produced by the main substrate 312 is directed downwards, and the light produced by the backlight substrate 309 is directed upwards. Thus, the retrofit LED has good light distribution pattern. In particular, when used indoor, the retrofit LED eliminates the dark celling effect. Furthermore, the intensity of the light produced by the backlight substrate 309 is set to between 10-15% of the intensity of the light produced by the main substrate 312, preferably as 10%, which is generally sufficient to illuminate the celling when used indoor, while at the same time saves significant power.

In accordance with this embodiment, the retrofit LED illuminates on both up and down directions, and the radiator 310 is tightly coupled with both the main substrate 312 and backlight substrate 309 to ensure good heat dissipation performance.

As shown in FIG. 4, the retrofit LED lamp includes a main cover 313 and a back cover 308 that are coupled together. The main cover 313 is installed over the main substrate 312, and the back cover 308 is installed over the backlight substrate 309. The main cover 313 is made of a non-diffused plastic material, and includes a non-diffused clear lens to further increase the lemon output. The back cover 308 is installed around the radiator 310.

As shown in FIG. 3, the divider ring 306 is installed at the lower portion of the radiator 310, and the cooling fan 305 is installed at the top of the radiator 310. The cooling fan 305 moves the air surrounding the radiator 310, actively dissipates heat generated by the LED lamp, and prevents the retrofit LED lamp from overheating. The divider ring 306 is used to prevent short-circuiting, and the LEDs from overheating.

In this embodiment, the cooling fan 305 and divider ring 306 can be connected through screws.

As shown in FIGS. 3 and 4, the radiator 310 is installed in a housing 304 in the shape of a truncated cone. The housing 304 is coupled to back cover 308 to form an integrated structure resembling a traditional lamp for better acceptance by consumers. The housing 304 is made of a non-heat conducting plastic material, and has a plurality of holes to allow the outflow of hot air inside the LED lamp.

A power supply board 303 is installed above the radiator 310, which contains a plurality of electric circuits. A connection sleeve 302 is placed above and houses the power supply board 3. A screw base 301 is connected to the top of the connection sleeve 302. A power supply line from the power supply board 303 is welded to the main substrate 312 after passing through the radiator 306 and, and another power supply line from the power supply board 303 is welded to the screw base 301 after passing through the connection sleeve 302.

The screw base 301 can be screwed into the sockets for metal halide lamp and high-pressure sodium lamp, and provides electrical connection for the LED lamp. The screw base 301 can be screwed into the sockets for metal halide lamp and high-pressure sodium lamp, and provides electrical connection for the LED lamp. The screw base 301 is compatible with the screw base for existing metal halide lamp and high-pressure sodium lamp, such as E39, EX39, or E40 base.

As shown in FIGS. 3 and 4, the retrofit LED lamp also includes a hook 307. The bottom of the hook 307 is affixed the housing 304. The hook 307 improves the safety of the retrofit LED lamp.

As can be seen from the above description, the LED lamp in this embodiment makes full use of an actively cooling assembly to effectively improve the heat dissipation performance of LED lamp, and reduce the size and the weight of LED lamp, so that the LED lamp has better safety, stability and reliability performances to effectively replace metal halide lamp and high-pressure sodium lamp. The active cooling assembly is much more effective than traditional passive cooling system, which primarily relies on the surface of the radiator to dissipate heat. Thus, to increase the surface area of the radiator and thus improve performance, passive cooling system often designs the housing as part of the radiator. To the contrary, the LED lamp in this embodiment does not use the housing 304 to dissipate heat, so that the LED lamp can have a compact package.

It has been shown that the LED lamp can effectively dissipate heat of more than 220 watts. Furthermore, this heat dissipation performance was achieved in a compact package, with a total weight of the LED lamp of about 1.1 kg, a height of the LED lamp of about 240 mm, and a height of the radiator of about 35 mm. As a result, the LED lamp can achieve a lifespan of more than 50,000 hours.

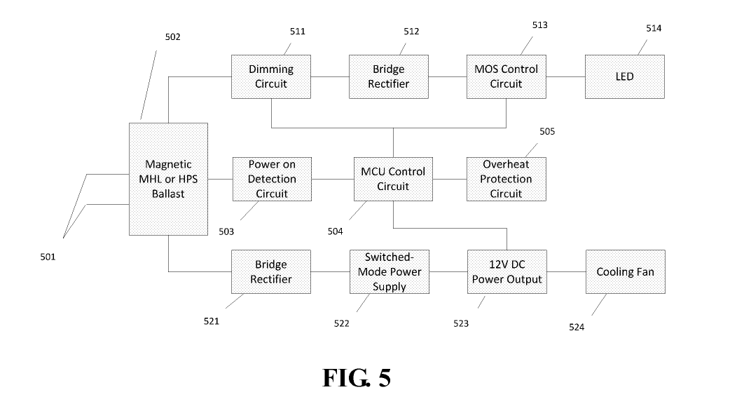

FIG. 5 is a schematic diagram of a power supply board for retrofit LED lamp as replacement for metal halide lamp and high-pressure sodium lamp, according to an embodiment of the present invention.

As shown in FIG. 5, there is a dimming circuit 511 placed between the ballast 502 and the bridge rectifier 512, and a MOS control circuit 513 between the ballast 502 and the LED 514. The bridge rectifier 512 converts the AC waveform of the ballast to a single sided waveform. The bridge rectifier 512 is made of four diodes arranged in a bridge manner, and a capacitor is placed in parallel to the bridge rectifier 512 to filters the single sided waveform to reduce the ripple current. Thus, the retrofit LED lamp can be used to replace existing metal halide lamp and high-pressure sodium lamp driven by the magnetic ballast. The retrofit LED lamp works on the electric current supplied by the magnetic ballast, and can directly replace the existing metal halide lamp high-pressure sodium lamp without removing the existing ballast.

The light adjustment circuit 511 and the MOS control circuit 513 can be used to adjust the electronic current, and consequently the intensity of the light produced by the LED 514. The light adjustment circuit 511 and the MOS control circuit 513 are both connected to a MCU control circuit 504. The MCU control circuit 504 controls the overall operation of the retrofit LED lamp. Importantly, the MCU control circuit 504 is connected to an overheat protection circuit 505. When the retrofit LED lamp is overheated, the overheat protection circuit 505 sends out a signal to the MCU control circuit 504, which in turn controls the silicon light modulator circuit 511 and MOS control circuit to either reduce the light intensity or shut down the retrofit LED lamp altogether. Also, the MCU control circuit 504 can turn on the cooling fan 524 to lower the temperature of the LED lamp. The MCU control circuit 504 is also connected to a power on detection circuit 503, which detects when the power for the retrofit LED is turned on.

The output from the MHL or HPS ballast is also feed as an input to another bridge rectifier 521 that convert the AC waveform generated by the magnetic MHL or HPS ballast 502 to a single sided waveform. The bridge rectifier 521 is similar to the bridge rectifier 512, and the output from the rectifier 521 has ripple current associated with it. The rectifier 512 is connected to a high-frequency switched-mode power supply 522, which produces a 12V DC power output 523. The power output 523 is connected to, and can be used to power a cooling fan 524, which can be used to lower the temperature of the retrofit LED. The power output 523 also supplies power to the MCU control circuit 504 through a voltage regulator.

The cooling fan 524 in FIG. 5 is the same as the cooling fan 305 in FIG. 3, and the LED 514 can be LEDs on either the main substrate 314 or backlight substrate 309 in FIG. 3. The cooling fan 524 or 305 can either function as an emergency cooling device, or as a regular cooling device. In particular, the incorporation of the MCU control circuit 504 makes the LED lamp an “intelligent” lamp, as the heat dissipation performance of the LED lamp can be easily customized based on the performance requirement. For example, the MCU control circuit 504 may start the cooling fan either when (1) the power on detection circuit 503 detects that the LED lamp is being turned on, or (2) the overheat protection circuit 505 sends a signal indicating that the temperature of the LED lamp is higher than the temperature preset by the user. In addition, the MCU control circuit can adjust the speed of the cooling fan based on the temperature of the LED lamp as measured by the overheat protection circuit 505.

The retrofit LED lamps in accordance with embodiments of the present invention are suitable to replace high power metal halide lamps and high-pressure sodium lamps, particularly those with power of more than 150 watts. The retrofit LED lamps can achieve almost 50% energy saving. For example, it has been shown that the LED lamp of 220 watts can deliver about 24,000 total lumens, with efficacy of about 110 lm/W, and can be used to replace metal halide lamp of 400 W. Furthermore, the retrofit LED lamps utilize existing fixtures and ballasts for metal halide lamps and high-pressure sodium lamps with no conversion expenses. Simply remove existing metal halide lamps and high-pressure sodium lamps, and screw in the retrofit LED lamps, and the replacement is complete.

In accordance with the embodiments of the present invention, the heat dissipation performance of the LED lamp is effectively improved, the size of the radiator and the weight of the LED lamp are reduced, the light distribution pattern of the LED lamp is optimized, and the LED lamp can directly replace the existing metal halide lamp and high-pressure sodium lamp.

The technical principles of the invention have been described above in conjunction with specific embodiments. These descriptions are only used for explaining the principles of the invention, rather than limiting the protection scope of the invention in any way. Other specific implementations may be made by one skilled in the art in light of the explanation herein without creative work, and all these implementations will fall into the protection scope of the invention.

1. An LED lamp for replacement of metal halide lamp and high-pressure sodium lamp, comprising a main substrate, an active cooling assembly comprising a radiator and a radiator base plate, a backlight substrate, and a screw base, wherein the main substrate is mounted on the lower side of the radiator base plate, the backlight substrate is mounted on an upper side of the radiator base plate, the backlight substrate is substantially in the shape of a ring and situated around the radiator, wherein the main substrate is configured to generate light illuminating downwards, the backlight substrate is configured to generate light illuminating upwards, and the screw base is configured to fit into a socket of a metal halide lamp or a high-pressure sodium lamp.

2. The LED lamp of claim 1, wherein the active cooling assembly further comprises a cooling fan, wherein the cooling fan is situated above the radiator.

3. The LED lamp of claim 2, further comprising a divider ring, wherein the divider ring is configured to prevent short-circuiting.

4. The LED lamp of claim 2, further comprises a housing substantially in the shape of truncated cone, wherein the housing is made from a non-heating conducting plastic material and comprises a plurality of holes configured to allow the outflow of hot air out of the LED lamp.

5. The LED lamp of claim 1, further comprising of a connection sleeve and a power supply board, wherein a top end of the connection sleeve is connected to a bottom end of the screw base, and the power supply board is situated inside the connection sleeve.

6. The LED lamp of claim 5, wherein a first power supply line on the power supply board is welded to the main substrate through the radiator and the radiator base plate, and a second power supply line on the power supply board is welded to the screw base through the connection sleeve.

7. The LED lamp of claim 6, wherein the power supply board comprises a first bridge rectifier configured to convert AC electric current supplied by a magnetic ballast for the metal halide lamp or high-pressure sodium lamp to DC power output for the main substrate and the backlight substrate.

8. The LED lamp of claim 7, wherein the power supply board comprises a second bridge rectifier configured to convert AC electric current supplied by the magnetic ballast to DC power output for the cooling fan.

9. The LED lamp of claim 8, wherein the power supply board further comprises a MCU control circuit, wherein the second bridge rectifier is configured to supply DC power output for the MCU control circuit.

10. The LED lamp of claim 9, wherein the power supply board further comprises an overheat protection circuit, wherein the MCU control circuit is configured to control the cooling fan in accordance with a signal from the overheat protection circuit.

11. The LED lamp of claim 10, wherein the power supply board further comprises a dimming circuit.

12. The LED lamp of claim 11, wherein the power supply board further comprises a power on detection circuit, wherein the MCU control circuit is configured to control the intensity of the light generated by the LED lamp through the dimming circuit in accordance with a signal from the power on detection circuit.

13. The LED lamp of claim 1, wherein the screw base is compatible with E39, EX39, and E40 mogul bases.

14. The LED lamp of claim 1, wherein the intensity of the light generated by the backlight substrate is between 10% and 15% of the intensity of the light generated by the main substrate.

15. The LED lamp of claim 1, wherein the radiator comprises a hollow heat dissipation tube configured to dissipate heat by phase-change heat absorption, a top and a bottom of the hollow heat dissipation tube are respectively configured as a condensation end and an evaporation end, the interior of the hollow heat dissipation tube is filled with a working medium and maintained at a negative pressure.

16. The LED lamp of claim 15, wherein a wall of the hollow heat dissipation tube comprises a heat absorption core configured to convey the working medium in a liquid state back to the evaporation end, and the heat absorption core is made of capillary porous material.

17. The LED lamp of claim 1, wherein the radiator comprises a plurality of heat dissipation fins of a wave or sawtooth shape radially distributed on the exterior radiator.

18. The LED lamp of claim 17, wherein the backlight substrate comprises a plurality of backlight aluminum substrates connected in series via bonding wires.

19. The LED lamp of claim 1, wherein the LED lamp has a weight of no greater than 1.1 kilogram, and is configured to generate no less than 20,000 lumens.

20. The LED lamp of claim 19, wherein the radiator has a height of no greater than 35 millimeters.

21. An LED lamp for replacement of metal halide lamp, comprising a main substrate, an active cooling assembly comprising a radiator and a radiator base plate, a backlight substrate, and a screw base, wherein the main substrate is mounted on the lower side of the radiator base plate, the backlight substrate is mounted on an upper side of the radiator base plate, the backlight substrate is substantially in the shape of a ring and situated around the radiator, wherein the main substrate is configured to generate light illuminating downwards, the backlight substrate is configured to generate light illuminating upwards, and the screw base is configured to fit into a socket of a metal halide lamp.

22. The LED lamp of claim 21, wherein the active cooling assembly further comprises a cooling fan, wherein the cooling fan is situated above the radiator.

23. The LED lamp of claim 21, further comprising of a connection sleeve and a power supply board, wherein a top end of the connection sleeve is connected to a bottom end of the screw base, and the power supply board is situated inside the connection sleeve.

24. The LED lamp of claim 6, wherein the power supply board is configured to convert power supply for the metal halide lamp to power output for the main substrate and the backlight substrate.

25. The LED lamp of claim 24, wherein the power supply board further comprises a control circuit.

26. The LED lamp of claim 25, wherein the power supply board further comprises a dimming circuit.

27. The LED lamp of claim 21, wherein the radiator comprises a hollow heat dissipation tube configured to dissipate heat by phase-change heat absorption, a top and a bottom of the hollow heat dissipation tube are respectively configured as a condensation end and an evaporation end, the interior of the hollow heat dissipation tube is filled with a working medium and maintained at a negative pressure.

28. The LED lamp of claim 27, wherein a wall of the hollow heat dissipation tube comprises a heat absorption core configured to convey the working medium in a liquid state back to the evaporation end, and the heat absorption core is made of capillary porous material.

29. The LED lamp of claim 21, wherein the radiator comprises a plurality of heat dissipation fins of a wave or sawtooth shape radially distributed on the exterior radiator.

30. The LED lamp of claim 29, wherein the backlight substrates comprises a plurality of backlight aluminum substrates connected in series via bonding wires.
